(19) United States
(12) Patent Application Publication
(10) Pub. No.: US 2005/0022645 A1
(43) Pub. Date: Feb. 3, 2005

(54) Tile cutter

(75) Inventor: Paul Steabben Hepworth, Guilford (GB)

Correspondence Address: NIKOLAI & MERSEREAU, P.A., 900 SECOND AVENUE SOUTH, SUITE 820, MINNEAPOLIS, MN, 55402, US

(73) Assignee: Turner Intellectual Property Limited, Burton-on-Trent (GB)

(21) Appl. No.: 10/899,721

(22) Filed: Jul. 22, 2004

Related U.S. Application Data
(63) Continuation of application No. PCT/GB03/00402, filed on Jan. 30, 2003.

(30) Foreign Application Priority Data
Jan. 30, 2002 (GB) 0202130.1

(51) Int. Cl. B26D 5/20; B26D 1/18

(52) U.S. Cl. 83/477.2

(57) ABSTRACT

A wet wheel cutter assembly including a cutter wheel (14) rotatably mounted in a housing (11), a worktable (12) mounted on the housing (11) upon which articles to be cut are placed, an upper portion of the cutter wheel (14) projecting above the worktop with the remainder of the cutter wheel (14) being located beneath the worktable (12), an open topped fluid container (60) secured by mounting means to the housing (11) for movement along a path of movement between first and second positions, the container (60) in its first position being located beneath the worktable (12) so that the lower portion of the cutter wheel (14) is located within the container (60), the container (60) in its second position being detachable from the housing (11) and being located at a position whereat the cutter wheel (14) is located outside the container (60).

According to one aspect of the present invention there is provided a wet wheel cutter assembly including a cutter wheel rotatably mounted in a housing, a worktable mounted on the housing upon which articles to be cut are placed, an upper portion of the cutter wheel projecting above the worktop with the remainder of the cutter wheel being located beneath the worktable, an open topped fluid container secured by mounting means to the housing for movement along a path of movement between first and second positions, the container in its first position being located beneath the worktable so that the lower portion of the cutter wheel is located within the container, the container in its second position being detachable from the housing and being located at a position whereat the cutter wheel is located outside the container.

Various aspects of the present invention are hereinafter described with reference to the accompanying drawings, in which:—

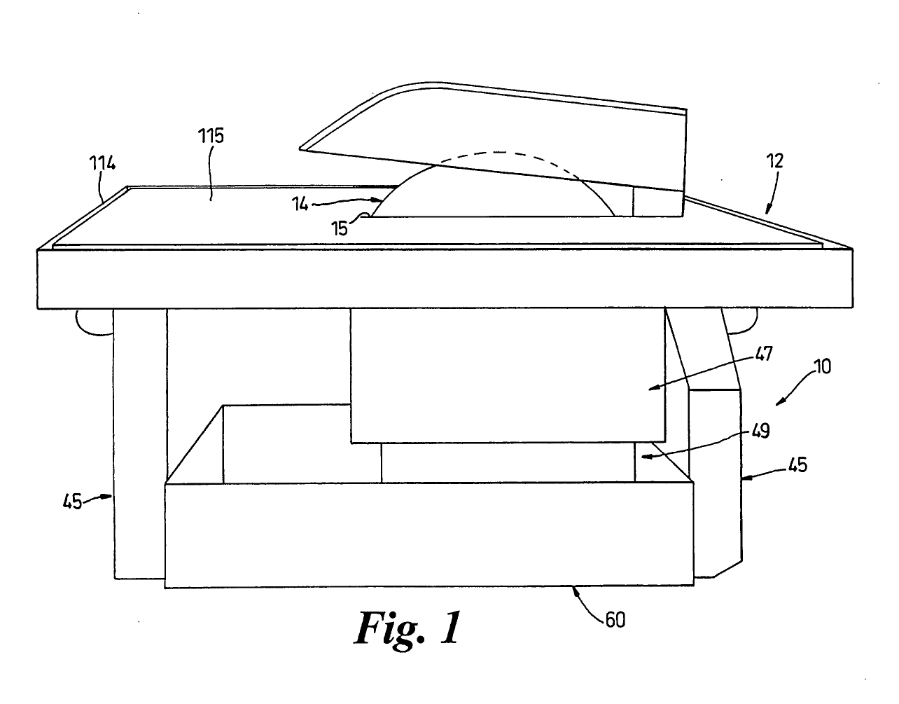

FIG. 1 is a rear end view of an embodiment according to the present invention;

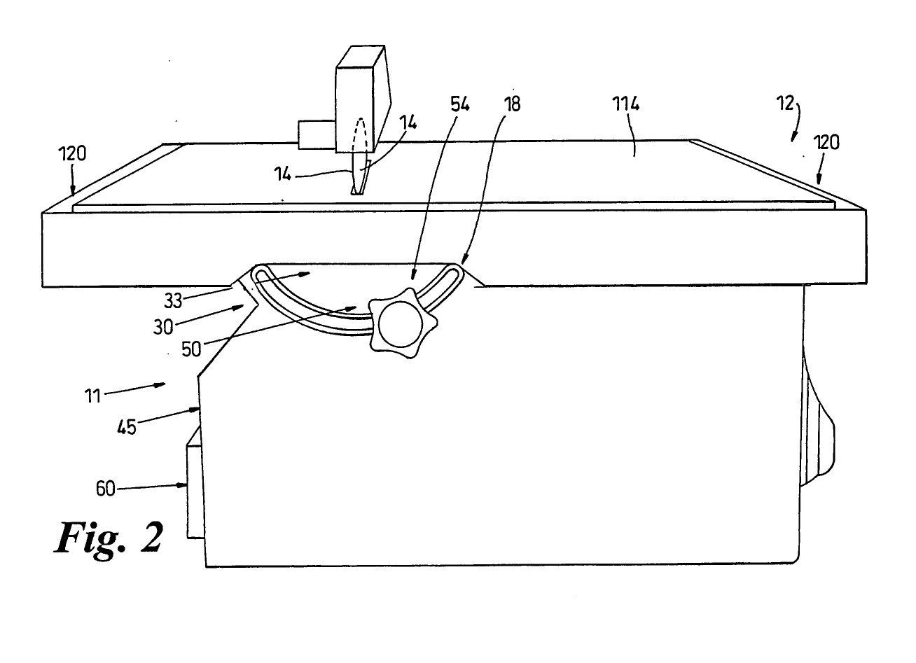

FIG. 2 is a side view of the embodiment shown in FIG. 1;

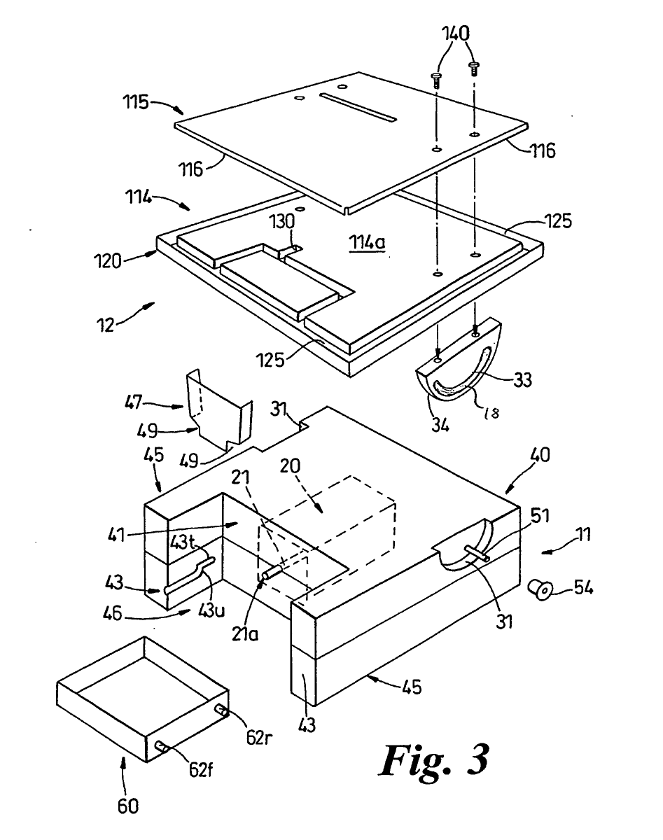

FIG. 3 is a schematic exploded view of the embodiment shown in FIG. 1; and

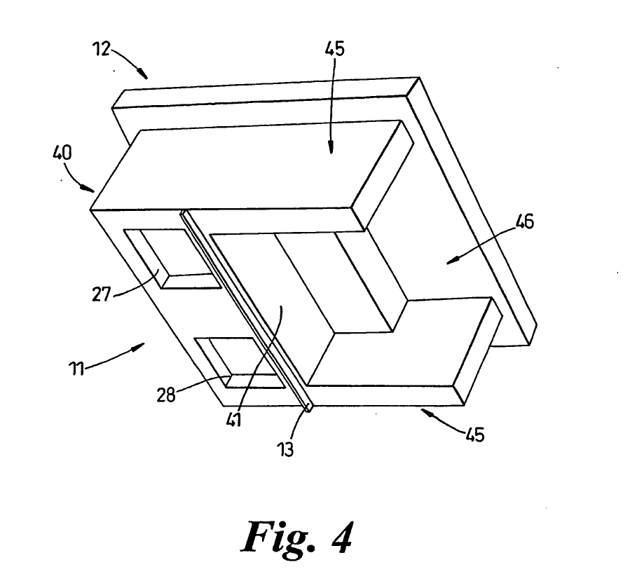

FIG. 4 is a schematic underside perspective view of the embodiment shown in FIG. 1.

A wet wheel tile cutter 10 according to a preferred embodiment of the present invention includes a main housing 11 upon which is seated a work table 12.

A rotatable cutter wheel 14 is rotatably mounted on the housing 11 such that an upper portion of the cutter wheel 14 protrudes by a predetermined height through a slot 15 formed in the table 12. Preferably the cutter wheel 14 is mounted on an output shaft 21 of an electric motor 20 which is fixedly mounted on the housing 11.

Preferably the housing 11 is moulded from a suitable plastics so as to include a hollow container portion 40 within which the motor 20 is housed. The hollow container portion 40 preferably includes top and bottom walls and opposed sidewalls so as to define a totally enclosed container.

The hollow container portion 40 includes an outside front wall 41 through which the shaft 21 sealingly extends. The shaft 21 thus has an end portion 21a which projects outside the housing and it is on this end portion that the cutter wheel is mounted.

Accordingly, the motor 20 is sealingly isolated from the cutter wheel.

The housing 11 preferably includes a pair of forwardly projecting wall supports 45 which project forwardly from the wall 41 to define an open fronted recess 46 in which the cutter wheel is located.

A removable cowling 47 is preferably provided which is attached to wall 41 so as to extend around the wheel cuter in order to shield the cutter wheel from the hands of an operative.

An open topped fluid container, preferably in the form of a tray 60 is provided which in use is located at a first position beneath the cutter wheel and cowling 47. The tray 60 is filled with a lubricant, usually water, so that on rotation of the cutter wheel water is picked up by the wheel and transported upwardly to the table to assist cutting of a tile on the table.

To ensure that water dripping from the cowling returns into the tray 60, the sides of the cowling 47 are preferably provided with cut-outs 49 which serve to define water sheds.

The tray 60 may be removed after cutting operations have been completed in order to empty the tray and wash out collected debris. In order to facilitate the removal of the tray 60 without causing tipping of the tray 60 and resultant spillage of water/slurry contained in the tray, it is mounted on the housing so as to be guided along a path of movement between the first position and a second position whereat it can-be detached from the housing. Preferably the mounting means define a slidable connection such that the tray 60 slidably engages the opposed side faces of walls 45 such that its forward/rearward movement is slidably guided thereby. In addition, the slidable engagement is such that the tray 60 is also slidably guided to rise/lower when near to its first, rearmost, position within the recess 46 so that when the tray 60 is pushed rearwardly it rises to an upper position whereat the cutter wheel and cowling are located within the tray 60; i.e. the lower portion of the cutter wheel and cowling are immersed within the water contained in the tray and so that when the tray 60 is pulled forwardly from its first, rearmost, position, the tray 60 is lowered such that the cutter wheel and cowling are spaced outside the tray 60 to thereby allow the tray 60 to be pulled forwardly out of the recess 46.

To achieve the guiding co-operation between the wall supports 45 and tray 60, it is envisaged that the internally facing surfaces of wall supports 45 could be provided with grooves 43 and that the sides of tray 60 be provided with projections 62 for slidable reception in the grooves 43. Preferably each side of the tray 60 is provided with a rearwardly and a forwardly located projection 62r, 62f respectively.

Initially projections 62r engage respective grooves 43 on insertion of the tray 60 into the recess 46 and guide its rearward movement into the recess 43. As the tray approaches its rearmost position the projections 62r engage the upwardly directed groove portion 43u and so cause the tray to rise. At this point, projections 62f have not yet entered the grooves 43.

When the projections 62r reach the upper track 43t of the grooves, the tray 60 has reached its uppermost position and further rearward movement causes the projections 62f to enter the grooves 43. The tray 60 is then supported on walls 45 by the co-operation of projections 62r, 62f and grooves 43.

Preferably, a latch, for example in the form of a stop (not shown) located in grooves 43 acts to releasably lock the tray 60 in its first position so as to prevent withdrawal of the tray 60 from that position.

Preferably, a water shed, in the form of a rib 13 continuously extends across the bottom wall of the hollow container adjacent to the lower edge of wall 41 to prevent water creeping along the outer face of the bottom wall of the container in which the motor 20 is housed. This enables ventilation ports 27, 28 for the motor to be provided in the bottom wall of the container in the form of simple apertures without the need to make special provision for preventing ingress of water.

The table 12 is preferably tiltably mounted on the housing 11 so as to be tiltable between a first limit position (as shown in FIG. 2) wherein the upper surface of the table 12 is perpendicular to the plane containing the cutter wheel 14 to a fully inclined position whereat the upper surface of the table 12 is located at a maximum inclined acute angle relative to the plane containing the cutter wheel 14.

Preferably the table 12 is tiltably mounted on the housing 11 by means of a pair of sliding bearing assemblies 30 located on opposed sides of the table 12.

Each bearing assembly 30 includes an upwardly facing seat 31 which is preferably semi-circular in shape formed on an upper portion of opposed housing sidewalls and a bearing block 33 mounted on the underside of the table 12, the bearing block 33 having a downwardly facing semi-circular edge 34 which is slidably received on the seat 31. The edge 34 and seat 31 have the same radius of curvature such that sliding movement of the edge 34 along the seat 31 causes the bearing block 33 to rotate about a discrete axis of rotation which is preferably arranged to pass through the diametric plane containing the wheel cutter.

Releasable locking means 50 are preferably provided for releasably locking the bearing block 33 in a desired rotary position relative to the seat 31 to thereby lock the table 12 at a desired inclined position.

The locking means 50 preferably comprises a threaded bolt 51 which passes through a bore formed in the housing sidewall and an arcuate slot 18 formed in the bearing block 33. A hand nut 54 is screw threadedly received on the bolt 51 so that rotation of the nut 54 in one direction causes it to grip the bearing block 33 to hold it in position and rotation in the opposite direction causes it to release the bearing block 33 to enable it to be rotated relative to the seat 34.

Preferably the table 12 comprises a table body 114 which supports a separate planar table top 115. The table top 115 defines the upper planar surface of the table 12 and is preferably formed from a metal sheet. Preferably the metal sheet has depending flanges 116 extending about its periphery which serve to give the metal sheet rigidity. Preferably the table top 14 is a metal pressing formed from a single sheet of metal.

The table body 114 is preferably a one piece plastics moulding having an upper support surface 114a which engages the lower face of the table top 115 in order to provide support therefore during use. Accordingly downward pressure applied by pressing down on the upper surface table top 115 is resisted by both the table top 115 and table body 114 without distortion of the table top 115. Accordingly, it is possible to form the table top 115 form a relatively thin sheet metal.

The table body 114 preferably extends beyond the periphery of the table top 115 so as to define the outer periphery of the table 12 and also define a marginal edge portion 120 which surrounds the table top 115. Accordingly, the lower edge of the flanges 116 are located inboard of the periphery of the table 12 and so are shielded by the table body 114 from the hands of an operative and so avoids possible injury caused by exposed edges of the metal sheet pressing.

Preferably the marginal edge portion 120 includes an open topped channel 125 which extends around the periphery of the table top 115. The channel 125 acts to collect water flowing off the table top 115 during use and permits the water to flow, in a constrained manner, to a drainage outlet 130 formed in the table body 114.

Preferably the drainage outlet 130 is located inboard of the periphery of the table top 115 to enable water/slurry which has collected in the channel 125 to drain downwardly into the tray 60 towards the rear of the tray 60.

Preferably the table top 115, table body 114 and bearing blocks 33 are fixedly secured together by means of fixing means such as screws or bolts 140. Dowel pins, not shown, may be provided in order to align the top 115, body 114 and blocks 33 prior to assembly.

Once the table 12 has been assembled, it is simply seated upon the housing 11 by locating the bearing blocks 33 within their respective seats 31 and these are secured together by the respective locking means 50.

Co-operation of the bearing blocks 33 and respective seats 31 serve to accurately position the table 12 relative to the housing 11 and cutter wheel 14.

Preferably the cutter wheel 14 is a wet diamond wheel.

1. A wet wheel cutter assembly including a cutter wheel rotatably mounted in a housing, a worktable mounted on the housing upon which articles to be cut are placed, an upper portion of the cutter wheel projecting above the worktop with the remainder of the cutter wheel being located beneath the worktable, an open topped fluid container secured by mounting means to the housing for movement along a path of movement between first and second positions, the container in its first position being located beneath the worktable so that the lower portion of the cutter wheel is located within the container, the container in its second position being detachable from the housing and being located at a position whereat the cutter wheel is located outside the container.

2. A wet wheel cutter assembly according to claim 1 wherein said mounting means defines a slidable connection between the container and housing for guiding movement of the container along said path of movement.

3. A wet wheel cutter assembly according to claim 2 wherein said slidable connection is defined by guide grooves formed on the housing co-operating with projections formed on the container.

4. A wet wheel cutter assembly according to claim 1, 2 or 3 wherein the mounting means releasably locks the container in its first position.

5. A wet wheel cutter assembly according to claim 1, 2 or 3 wherein the worktable is tiltably mounted on the housing between a first limit position and a fully inclined position.

6. A wet wheel cutter assembly according to claim 1 wherein the worktable is tiltably mounted on the housing by means of a pair of sliding bearing assemblies located on opposed sides of the table.

7. A wet wheel cutter assembly according to claim 6 wherein each assembly includes an upwardly facing seat formed on an upper portion of the housing and a bearing block mounted on the worktable, the bearing block having a downwardly facing semi-circular edge slidably received on said seat, the bearing block co-operating with the seat to cause the bearing block to rotate about a discrete axis of rotation.

8. A wet wheel cutter assembly according to any one of claims 1-3, 6 or 7 wherein the worktable comprises a table body which supports a separate planar table top.

9. A wet wheel cutter assembly according to claim 1 wherein the work table comprises a table body that supports a planar table top where the table body extends beyond the periphery of the table top defines the outer periphery of the worktable and to also define a marginal edge portion which surrounds the table top, the marginal edge portion including an open topped drainage channel which communicates with a drainage outlet formed in the table body, the drainage outlet being located inboard of the periphery of the table top.

10. A wet wheel cutter assembly according to claim 9 wherein the table body is a plastics moulding and the table top is a metal pressing.
